(19) United States
(12) Patent Application Publication
(10) Pub. No.: US 2024/0149413 A1
(43) Pub. Date: May 9, 2024

(54) REMOVAL TOOLING FOR CLUTCH OF GEARBOX

(71) Applicant: Shenzhen Dapeng Auto Tools Co., Ltd., Shenzhen (CN)

(72) Inventor: Wenpeng YUE, Shenzhen (CN)

(73) Assignee: Shenzhen Dapeng Auto Tools Co., Ltd., Shenzhen (CN)

(21) Appl. No.: 17/981,437

(22) Filed: Nov. 6, 2022

(51) Int. Cl. B25B 27/00

(52) U.S. Cl. CPC B25B 27/0064; F16H 2057/0062

(57) ABSTRACT

A removal tooling for a clutch of a gearbox includes an upper bracket, a lower bracket, a main screw and a pulling claw. The upper bracket has a middle portion vertically provided with threaded holes, and a bottom surface fixedly connected with connecting posts distributed at equal angular distances around an axis of the threaded hole. The lower bracket has a main body fixedly connected to a lower end of the connecting post, and a circumference of the main body has cantilevers distributed at equal angular distances around the axis of the threaded hole. The main screw penetrates through the threaded hole from top to bottom. There are a plurality of pulling claws which are fixed on a bottom surface of the cantilever in one-to-one correspondence, and a lower end of the pulling claw forms a claw portion which is buckled inward.

### TECHNICAL FIELD

The invention relates to the technical field of automobile maintenance, in particular, to a removal tooling for a clutch of gearbox.

### BACKGROUND

When an automobile gearbox is repaired, the clutch in the gearbox needs to be disassembled, and the clutch is tightly adhered by the sealant while the operating space in the gearbox housing being narrow, resulting in difficulties in disassembling the clutch.

Therefore, there is an urgent need to provide a removal tooling to assist in disassembling the clutch of gearbox.

### SUMMARY

The invention aims at providing a removal tooling for a clutch of gearbox, so as to assist in the disassembly of the clutch, which has the following technical solutions:

A removal tooling for a clutch of gearbox includes:

an upper bracket, having a middle portion vertically provided with threaded holes and a bottom surface fixedly connected with at least three connecting posts distributed at equal angular distances around an axis of the threaded hole;

a lower bracket, having a main body fixedly connected to a lower end of the connecting post, wherein a circumference of the main body has at least three cantilevers distributed at equal angular distances around the axis of the threaded hole;

a main screw, penetrating through the threaded hole from top to bottom to form a threaded connection;

a pulling claw, having a plurality of pulling claws which are fixed on a bottom surface of the cantilever in one-to-one correspondence, wherein a lower end of the pulling claw forms a claw portion which is buckled inwardly towards the axis of the threaded hole;

wherein the cantilever extends radially outward along the threaded hole, the cantilever is provided with long holes that run vertically, a length direction of the long hole is arranged radially along the threaded hole, and a cock bolt that penetrates downward into the long hole is provided on a top surface of the cantilever; a top surface of the pulling claw is provided with a blind hole for the cock bolt to be screwed with so that the pulling claw is pulled upwardly and anchored to the bottom surface of the cantilever through the cock bolt.

When the above removal tooling for a clutch of gearbox is used, first the gearbox is fixed to face the bottom surface of the lower bracket towards the gearbox, then the pulling claw is converged concentrically along the long hole by way of adjusting the cock bolt in tightness and is further buckled between a washer of a forward gear of the clutch and a clutch bag through the claw portion of the pulling claw, and then the above removal tooling for a clutch of gearbox is dragged through the main screw, so as to finally disassemble the clutch from the gearbox easily.

In the above technical solutions, the radial expansion and contraction of the main screw may be realized by twisting the main screw. In view of the fact that the upper bracket and the lower bracket constitute an elevated cage-like bracket through the connecting posts, the main screw has a telescopic adjustment stroke outside the gearbox, which is not limited by the narrow space in the gearbox housing.

Compared with the prior art, the invention has the following beneficial effects: the invention is very suitable for operation in the narrow space in the gearbox housing, and the clutch may be easily disassembled.

The invention is further described below with reference to the accompanying drawings and specific implementations of the specification.

### BRIEF DESCRIPTION OF DRAWINGS

FIG. 1 is a structure diagram of the invention.

FIG. 2 is an exploded structure diagram of the invention.

FIG. 3 is a structure diagram of a connection post of the invention.

FIG. 4 is a structure diagram of a pulling claw of the invention.

### DETAILED DESCRIPTION OF THE EMBODIMENTS

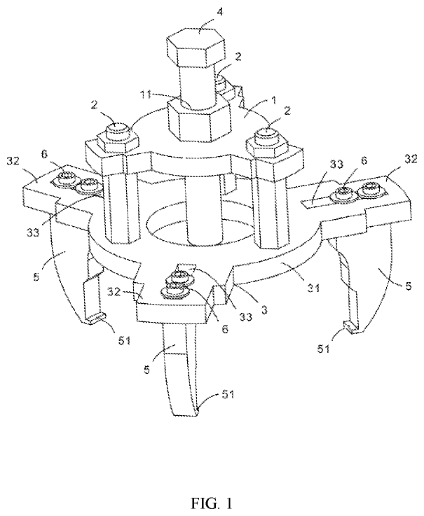

As shown in FIG. 1, in an embodiment, a removal tooling for a clutch of gearbox of the invention includes:

an upper bracket 1, which has a middle portion vertically provided with threaded holes 11 and a bottom surface fixedly connected with at least three connecting posts 2 distributed at equal angular distances around an axis of the threaded hole 11;

a lower bracket 3, which has a main body 31 fixedly connected to a lower end of the connecting post 2, wherein a circumference of the main body 31 has at least three cantilevers 32 distributed at equal angular distances around the axis of the threaded hole 11;

a main screw 4, which penetrates through the threaded hole 11 from top to bottom to form a threaded connection;

a pulling claw 5, which has a plurality of pulling claws which are fixed on a bottom surface of the cantilever 32 in one-to-one correspondence, wherein a lower end of the pulling claw 5 forms a claw portion 51 which is buckled inwardly towards the axis of the threaded hole 11;

wherein the cantilever 32 extends radially outward along the threaded hole 11, the cantilever 32 is provided with long holes 33 that run vertically, a length direction of the long hole 33 is arranged radially along the threaded hole 11, and a cock bolt 6 that penetrates downward into the long hole 33 is provided on a top surface of the cantilever 32; a top surface of the pulling claw 5 is provided with a blind hole 52 for the cock bolt 6 to be screwed with so that the pulling claw 5 is pulled upwardly and anchored to the bottom surface of the cantilever 32 through the cock bolt 6.

When the above removal tooling for a clutch of gearbox is used, first the gearbox is fixed to face the bottom surface of the lower bracket 3 towards the gearbox, then the pulling claw 5 is converged concentrically along the long hole 33 by way of adjusting the cock bolt 6 in tightness and is further buckled between a washer of a forward gear of the clutch and a clutch bag through the claw portion 51 of the pulling claw 5, and then the above removal tooling for a clutch of gearbox is dragged through the main screw 4, so as to finally disassemble the clutch from the gearbox easily.

In the above embodiment, the radial expansion and contraction of the main screw 4 may be realized by twisting the main screw 4. In view of the fact that the upper bracket 1 and the lower bracket 3 constitute an elevated cage-like bracket through the connecting posts 2, the main screw 4 has a telescopic adjustment stroke outside the gearbox, which is not limited by the narrow space in the gearbox housing.

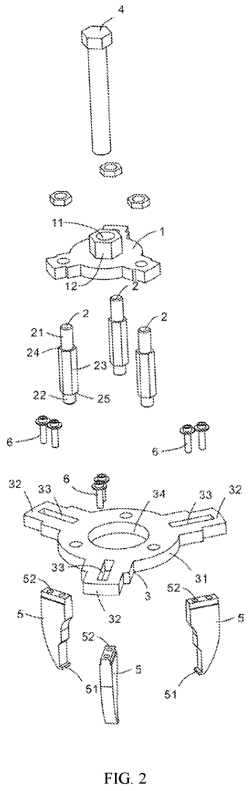

In a preferred embodiment, as shown in FIGS. 1 and 2, the main body 31 of the lower bracket 3 is vertically provided with a through hole 34 that is coaxial with the threaded hole 11, and a diameter of the through hole 34 is greater than an outer diameter of the main screw 4. Therefore, the telescopic adjustment stroke of the main screw 4 may pass through the through hole 34 so as to obtain a larger stroke range.

In a preferred embodiment, as shown in FIG. 2, an upper section of the connecting post 2 is made into an upper threaded section 21, and the upper threaded section 21 penetrates upward from a bottom surface of the upper bracket 1 to form a bolt connection; a lower section of the connecting post 2 is made into a lower threaded section 22, and the lower threaded section 22 penetrates downward from a top surface of the lower bracket 3 to form a bolt connection. Therefore, the removal tooling for a clutch of gearbox of the invention may be stored after being disassembled.

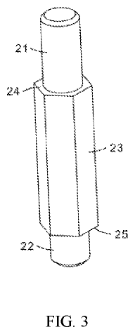

Further, as shown in FIG. 3, a middle section of the connecting post 2 is made into a support section 23 with an outer diameter larger than the upper threaded section 21 and the lower threaded section 22, an upper end of the support section 23 forms an upper support surface 24 surrounding the upper threaded section 21 to abut against the bottom surface of the upper bracket 1, and a lower end of the support section 23 forms a lower support surface 25 surrounding the lower threaded section 22 to abut the top surface of the lower bracket 3.

Further, as shown in FIG. 3, the support section 23 is a hexagonal post, which is convenient for twisting operation with a hexagonal wrench.

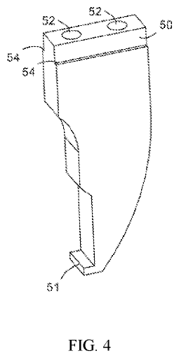

In a preferred embodiment, as shown in FIG. 4, an upper section of the pulling claw 5 forms a tenon 50 that may be just inserted into a lower edge of the long hole 33, and a lower edge of the tenon 50 forms an abut surface 53 that is wider than the long hole 33 to abut against the bottom surface of the cantilever 32. When the pulling claw 5 is pulled up and anchored on the bottom surface of the cantilever 32 by the cock bolt 6, the tenon 50 is just inserted into the lower edge of the long hole 33, and the abut surface 53 just abuts the bottom surface of the cantilever 32, so that a more reliable circumferential limit may be realized for the pulling claw 5, and the installation is more firm without being easy to loosen.

In a preferred embodiment, as shown in FIGS. 1 and 2, a top surface of the upper bracket 1 is provided with a boss 12 that protrudes upwardly at a middle portion thereof, and the threaded hole 11 is provided on the boss 12. An axial length of the threaded hole 11 is substantially increased by the boss 12, so that the main screw 4 has better mechanical strength in the upper bracket 1.

For those skilled in the art, the protection scope of the invention is not limited to the details of the above-mentioned exemplary embodiments. Without departing from the spirit or basic features of the invention, those skilled in the art make equivalent meanings based on the requirements of the invention and all modified embodiments within the protection scope shall be included in the invention.

What is claimed is:

1. A removal tooling for a clutch of gearbox, comprising:
an upper bracket, having a middle portion vertically provided with threaded holes and a bottom surface fixedly connected with at least three connecting posts distributed at equal angular distances around an axis of the threaded hole;
a lower bracket, having a main body fixedly connected to a lower end of the connecting post, wherein a circumference of the main body has at least three cantilevers distributed at equal angular distances around the axis of the threaded hole;
a main screw, penetrating through the threaded hole from top to bottom to form a threaded connection;
a pulling claw, having a plurality of pulling claws which are fixed on a bottom surface of the cantilever in one-to-one correspondence through bolts, wherein a lower end of the pulling claw forms a claw portion which is buckled inwardly towards the axis of the threaded hole;
wherein the cantilever extends radially outward along the threaded hole, the cantilever is provided with long holes that run vertically, a length direction of the long hole is arranged radially along the threaded hole, and a cock bolt that penetrates downward into the long hole is provided on a top surface of the cantilever; a top surface of the pulling claw is provided with a blind hole for the cock bolt to be screwed with so that the pulling claw is pulled upwardly and anchored to the bottom surface of the cantilever through the cock bolt.

2. The removal tooling for a clutch of gearbox according to claim 1, wherein the main body of the lower bracket is vertically provided with a through hole that is coaxial with the threaded hole, and a diameter of the through hole is greater than an outer diameter of the main screw.

3. The removal tooling for a clutch of gearbox according to claim 1, wherein an upper section of the connecting post is made into an upper threaded section, and the upper threaded section penetrates upward from a bottom surface of the upper bracket to form a bolt connection; a lower section of the connecting post is made into a lower threaded section, and the lower threaded section penetrates downward from a top surface of the lower bracket to form a bolt connection.

4. The removal tooling for a clutch of gearbox according to claim 3, wherein a middle section of the connecting post is made into a support section with an outer diameter larger than the upper threaded section and the lower threaded section, an upper end of the support section forms an upper support surface surrounding the upper threaded section to abut against the bottom surface of the upper bracket, and a lower end of the support section forms a lower support surface surrounding the lower threaded section to abut the top surface of the lower bracket.

5. The removal tooling for a clutch of gearbox according to claim 4, wherein the support section is a hexagonal post.

6. The removal tooling for a clutch of gearbox according to claim 1, wherein an upper section of the pulling claw forms a tenon that may be just inserted into a lower edge of the long hole, and a lower edge of the tenon forms an abut surface that is wider than the long hole to abut against the bottom surface of the cantilever.

7. The removal tooling for a clutch of gearbox according to claim 1, wherein a top surface of the upper bracket is provided with a boss that protrudes upwardly at a middle portion thereof, and the threaded hole is provided on the boss.
